(19) United States
(12) Patent Application Publication
(10) Pub. No.: US 2026/0265121 A1
(43) Pub. Date: Sep. 10, 2026

(54) CRYSTALLIZED GLASS

(71) Applicant: OHARA INC., SAGAMIHARA-SHI, KANAGAWA (JP)

(72) Inventors: SAYA KIKKAWA, SAGAMIHARA-SHI, KANAGAWA (JP); TOSHITAKA YAGI, SAGAMIHARA-SHI, KANAGAWA (JP)

(21) Appl. No.: 19/165,137

(22) PCT Filed: Feb. 29, 2024
(86) PCT No.: PCT/JP2024/007604

§ 371 Date: Sep. 14, 2025

(30) Foreign Application Priority Data
Mar. 13, 2023 (JP) 2023-039063

(51) Int. Cl. C03C 10/00

(52) U.S. Cl. CPC C03C 10/0045

(57) ABSTRACT

A crystallized glass containing, in mass % on an oxide basis, a SiO₂ component: 40.0 to 55.0%, an Al₂O₃ component: 10.0 to 30.0%, a MgO component: 10.0 to 30.0%, a TiO₂ component: 5.0 to 15.0%, a Li₂O component: more than 0 to 5.0%, and a Na₂O component: more than 0 to 8.0%, in which a total content of the Li₂O component, the Na₂O component, and the K₂O component [content of Li₂O component+content of Na₂O component+content of K₂O component] is more than 0 to 12.0%, a Vickers hardness (Hv) is 700 or more, and a spectral transmittance at 400 nm measured for a 1 mm thick sample is 60% or more.

### FIELD OF THE DISCLOSURE

The present invention relates to a crystallized glass having a novel composition.

### BACKGROUND OF THE DISCLOSURE

Conventionally, a glass is used as a cover glass for protecting a display in a portable electronic device such as a smartphone or a tablet PC, and as a protector for protecting a lens of an in-vehicle optical device. Furthermore, in recent years, there is also a demand for use in a housing or the like as an exterior of an electronic device. Then, there is an increasing demand for a material having a high strength so that these devices can withstand severe use. Furthermore, as these applications, a material having a high transmittance while maintaining a high strength is required.

A crystallized glass is known as a glass having an increased strength. A crystallized glass is obtained by precipitating crystals inside a glass, and usually has a higher mechanical strength than a glass.

Patent Literature 1 discloses a material composition of a crystallized glass substrate for an information magnetic recording medium. Patent Literature 1 describes that a glass ceramic substrate having a crystalline phase such as enstatite has a high Young's modulus corresponding to high-speed rotation and is suitable for an information magnetic recording medium.

The present inventors have filed a novel glass in Patent Literature 2. This glass can be crystallized and chemically strengthened, which can increase the mechanical strength. At present, due to the increasing demand, there is a demand for a crystallized glass having higher transparency while maintaining the mechanical strength of the crystallized glass obtained in examples of this application.

### CITATION LIST

### Patent Literature

Patent Literature 1: JP 2001-048581 A
Patent Literature 2: JP 2022-30556 A

### SUMMARY OF THE DISCLOSURE

An object of the present invention is to provide a crystallized glass having a high strength (hardness) and excellent transparency, and a strengthened crystallized glass having excellent impact resistance.

As a result of intensive studies to solve the above problems, the present inventors have found that a crystallized glass excellent in both strength (hardness) and transparency can be obtained when specific composition and condition are satisfied, and that a strengthened crystallized glass having high impact resistance can be realized when the crystallized glass is subjected to a strengthening treatment, thereby completing the present invention.

The present invention provides the following.

### (Configuration 1)

A crystallized glass containing, in mass % on an oxide basis:
a SiO₂ component: 40.0 to 55.0%,
an Al₂O₃ component: 10.0 to 30.0%,
a MgO component: 10.0 to 30.0%,
a TiO₂ component: 5.0 to 15.0%,
a Li₂O component: more than 0 to 5.0%, and
a Na₂O component: more than 0 to 8.0%, in which
a total content of the Li₂O component, the Na₂O component, and the K₂O component [content of Li₂O component+content of Na₂O component+content of K₂O component] is more than 0 to 12.0%,
a Vickers hardness (Hv) is 700 or more, and
a spectral transmittance at 400 nm measured for a 1 mm thick sample is 60% or more.

### (Configuration 2)

The crystallized glass according to configuration 1, in which the content of the MgO component with respect to a total content of the MgO component, a CaO component, a SrO component, a BaO component, and a ZnO component [content of MgO component/(content of MgO component+content of CaO component+content of SrO component+content of BaO component+content of ZnO component)] is 0.45 or more.

### (Configuration 3)

The crystallized glass according to configuration 1 or 2, containing, in mass % on an oxide basis:
a B₂O₃ component: 0 to 5.0%,
a P₂O₅ component: 0 to 5.0%,
a K₂O component: 0 to 5.0%,
a CaO component: 0 to 5.0%,
a SrO component: 0 to 5.0%,
a BaO component: 0 to 5.0%,
a ZnO component: 0 to 5.0%,
a ZrO₂ component: 0 to 8.0%, and
a Sb₂O₃ component: 0 to 2.0%.

### (Configuration 4)

An inorganic composition article having a compressive stress layer on a surface thereof, obtained by chemically strengthening the crystallized glass according to configuration 1 or 2.

### (Configuration 5)

The inorganic composition article according to configuration 4, in which the ratio of the thickness DOLzero of the compressive stress layer on the surface to the thickness t of the substrate of the inorganic composition article (DOLzero/t) is 7% or more and 25% or less.

According to the present invention, it is possible to provide a crystallized glass having a high strength (hardness) and excellent transparency, and a strengthened crystallized glass having excellent impact resistance.

### BRIEF DESCRIPTION OF THE DRAWINGS

FIG. 1 is an X-ray diffraction spectrum obtained in Example 2.

### DETAILED DESCRIPTION OF THE EXEMPLARY EMBODIMENTS

Hereinafter, embodiments and examples of a crystallized glass and the like of the present invention will be described in detail, but the present invention is not limited to the following embodiments and examples, and can be implemented with appropriate modifications within the scope of the object of the present invention.

### [Crystallized Glass]

A crystallized glass according to one aspect of the present invention contains, in mass % on an oxide basis:
a SiO₂ component: 40.0 to 55.0%,
an Al₂O₃ component: 10.0 to 30.0%,
a MgO component: 10.0 to 30.0%,
a TiO₂ component: 5.0 to 15.0%,
a Li₂O component: more than 0 to 5.0%, and
a Na₂O component: more than 0 to 8.0%, in which
a total content of the Li₂O component, the Na₂O component, and the K₂O component [content of Li₂O component+content of Na₂O component+content of K₂O component] is more than 0 to 12.0%, and
a Vickers hardness (Hv) is 700 or more, and
a spectral transmittance at 400 nm measured for a 1 mm thick sample is 60% or more.

In the present description, the contents of respective components are all expressed in mass % on an oxide basis unless otherwise specified. Here, the expression “on an oxide basis” refers to the amount of an oxide of each component contained in the crystallized glass expressed in mass % when the total mass of oxides is taken as 100 mass % assuming that all the constituent components of the crystallized glass are decomposed and converted to oxides. In the present description, A % to B % represent A % or more and B % or less.

The crystallized glass according to one aspect of the present invention has the above configuration, and thus has a high strength (hardness) and excellent transparency. Therefore, it can be used as a member of a cover glass or a housing of a smartphone, a member of a portable electronic device such as a tablet PC or a wearable terminal, or a member of a protective protector or a substrate for a head-up display used in a transport body such as a car or an airplane, and the high transparency of the crystallized glass can improve the utility value of each device.

Hereinafter, each configuration of the crystallized glass will be described.

### <Crystallized Glass>

A crystallized glass is also called a glass ceramic, and is a material in which crystals are precipitated inside a glass by subjecting the glass to a heat treatment. The crystallized glass is a material having a crystalline phase and a glass phase, and is distinguished from an amorphous solid. In general, a crystalline phase of a crystallized glass is discriminated by using an angle of a peak appearing in an X-ray diffraction pattern of X-ray diffraction analysis and an electron diffraction method as necessary.

Examples of the crystalline phase of the crystallized glass according to an aspect of the present invention include (Mg, Ti)O, MgAl₂Si₂O₈, MgSiO₃, MgTi₂O₅, Mg₂SiO₄, Na₂TiSiO₅, MgAl₂O₄, Mg₂Al₂Si₃O₁₂, and solid solutions thereof.

### (Vickers Hardness (Hv))

The crystallized glass has a Vickers hardness (Hv) of 700 or more. By having such a hardness (strength), it can withstand the impact at the time of dropping when used as a protective member. In one aspect, the Vickers hardness (Hv) is 720 or more, 730 or more, 750 or more, or 770 or more. The upper limit value is not particularly limited, but may be, for example, 855 or less or 850 or less.

The Vickers hardness (Hv) is measured by a method described in examples.

### (Light Transmittance)

The crystallized glass has a spectral transmittance of 60% or more at 400 nm measured for a 1 mm thick sample, and has high transparency. In one aspect, the spectral transmittance is 65% or more, 70% or more, 75% or more, or 80% or more.

In one aspect, the crystallized glass has a spectral transmittance of 70% or more, for example, 75% or more, or 80% or more at 550 nm measured for a 1 mm thick sample.

In one aspect, the crystallized glass has a spectral transmittance of 70% or more, for example, 75% or more, 80% or more, or 85% or more at 700 nm measured for a 1 mm thick sample.

The spectral transmittance (%) is measured by the method described in examples.

### (Method for Producing Crystallized Glass)

The crystallized glass of the present invention can be produced by adjusting a raw material composition and production conditions in accordance with a production method and examples described later.

In the crystallized glass of the present invention, a compressive stress layer can be formed on a surface by various strengthening methods (chemical strengthening method, thermal strengthening method, ion implantation method, and the like). The strengthening methods will be described later.

Specifically, the crystallized glass can be produced by the following method. That is, raw materials are uniformly mixed so that the content of each component falls within a predetermined range, and melted to produce a raw glass. Subsequently, the raw glass is crystallized to produce a crystallized glass.

### (Raw Glass)

The composition of the crystallized glass, that is, the content of each component of the raw glass will be described.

A SiO₂ component is an essential component that forms a glass network structure. The lower limit of the content of the SiO₂ component can be, for example, 40.0% or more, 41.0% or more, or 42.0% or more. The upper limit of the content of the SiO₂ component may be, for example, 55.0% or less, 50.0% or less, 49.0% or less, or 48.0% or less.

An Al₂O₃ component forms a glass network structure similarly to SiO₂, and is an essential component that can be a component constituting a crystalline phase by a heat treatment of a glass before crystallization. In addition, the component contributes to improvement of mechanical strength. The lower limit of the content of the Al₂O₃ component can be, for example, 10.0% or more, 13.5% or more, or 15.0% or more. The upper limit of the content of the Al₂O₃ component can be, for example, 30.0% or less, 25.0% or less, or 23.0% or less.

A MgO component is one of the components that can form a crystalline phase and is an essential component. In addition, the component contributes to improvement of mechanical strength. The lower limit of the content of the MgO component can be, for example, 10.0% or more, 13.5% or more, or 15.0% or more. The upper limit of the content of the MgO component may be, for example, 30.0% or less, 25.0% or less, or 23.0% or less.

The TiO₂ component is an essential component that plays a role of nucleation for precipitating crystals. In addition, the component contributes to improvement of mechanical strength. The lower limit of the content of the TiO₂ component can be, for example, 5.0% or more, 6.0% or more, or 7.0% or more. The upper limit of the content of the TiO₂ component can be, for example, 15.0% or less, 14.0% or less, or 13.0% or less.

A Li₂O component is an essential component involved in chemical strengthening and contributing to improvement of mechanical strength. Specifically, the crystallized glass containing a predetermined amount of Li₂O has a high capability of coping with a strengthening treatment, and it becomes possible to produce a strengthened crystallized glass having a compressive stress layer having a sufficient thickness.

When the content of the Li₂O component is 5.0% or less, it is possible to prevent devitrification, phase separation, or non-uniformization of a glass. Therefore, the upper limit of the content of the Li₂O component can be, for example, 5.0% or less, 4.0% or less, 3.0% or less, 2.5% or less, or 2.0% or less. The lower limit value is, for example, more than 0%, 0.1% or more, 0.3% or more, or 0.5% or more.

A Na₂O component is an essential component involved in chemical strengthening and contributing to improvement of mechanical strength. The lower limit of the content of the Na₂O component can be, for example, more than 0%, 0.5% or more, 1.0% or more, 2.0% or more, or 3.0% or more.

When the content of the Na₂O component is 8.0% or less, it is possible to prevent devitrification, phase separation, or non-uniformization of a glass. Therefore, the upper limit of the content of the Na₂O component can be, for example, 8.0% or less, 7.0% or less, 6.0% or less, 5.0% or less, or 4.5% or less.

Each of a B₂O₃ component and a P₂O₅ component can be added as an optional component. The optional component is a component that may or may not be contained. The content can be 0% or more.

The upper limit of the content of each of these components can be, for example, 5.0% or less, 3.0% or less, or 2.0% or less. The content of the B₂O₃ component may be 0 to less than 2.0% or 0 to 1.0%.

Both the Na₂O component and the Li₂O component are involved in chemical strengthening, but when the total content is 77.0% or less, deterioration of devitrification can be prevented, and thus the total content is preferably 7.0% or less, and more preferably 5.0% or less.

Each of a K₂O component, a CaO component, a SrO component, a BaO component, and a ZnO component can be added as an optional component. The upper limit of the content of each of these components can be, for example, 5.0% or less, 3.0% or less, 2.5% or less, or 2.0% or less.

In particular, when the CaO component and the SrO component are contained in an amount of more than 0%, the lower limit thereof can be preferably more than 0% and more preferably 0.5% or more in order to improve the mechanical strength.

The total content of the Li₂O component, the Na₂O component, and the K₂O component [content of Li₂O component+content of Na₂O component+content of K₂O component] is more than 0, for example, 1.0% or more, 2.0% or more, 3.0% or more, or 4.0% or more. The upper limit value is, for example, 12.0% or less, 10.0% or less, or 8.0% or less. Within such a range, it is possible to have a compressive stress layer having a sufficient thickness and a strong stress with a high capability of coping with a strengthening treatment while having the stability of a glass.

In one aspect, the content of the MgO component with respect to the total content of the MgO component, the CaO component, the SrO component, the BaO component, and the ZnO component [content of MgO component/(content of MgO component+content of CaO component+content of SrO component+content of BaO component+content of ZnO component)] is 0.45 or more, for example, 0.5 or more, 0.6 or more, 0.7 or more, or 0.8 or more. The upper limit value is, for example, 1.5 or less, 1.3 or less, 1.2 or less, 1.1 or less, 1.0 or less, 0.98 or less, or 0.95 or less. Within such a range, it is possible to obtain a material having a high capability of coping with chemical strengthening while improving the mechanical strength by having crystals.

A ZrO₂ component is an optional component that can play a role of nucleation for precipitating crystals. The upper limit of the content of the ZrO₂ component can be, for example, 8.0% or less, 5.0% or less, or 3.0% or less.

The glass may contain a Gd₂O₃ component, a TeO₂ component, a FeO component, a La₂O₃ component, a Y₂O₃ component, a Nb₂O₅ component, a Ta₂O₅ component, and a WO₃ component as optional components as long as the effect of the present invention is not impaired. The content of each component can be 0 to 2.0% or 0.5 to 1.0%.

The glass can contain, as a clarifying agent, one or more types selected from an Sb₂O₃ component, an SnO₂ component, and a CeO₂ component in an amount of 0 to 2.0%, preferably 0.005 to 1.0%, and more preferably 0.01 to 0.5%.

Since each component of Pb, Th, Cd, Tl, Os, Be, and Se tends to be refrained from being used as they are harmful chemical substances in recent years, it is preferable that these components are not substantially contained. The phrase “are not substantially contained” refers to a case where these are contained as inevitable impurities or are not contained at all. The total amount of these components is, for example, 0.1% or less.

The above blending amounts can be appropriately combined.

In one aspect, the total content of the SiO₂ component, the Al₂O₃ component, the MgO component, the TiO₂ component, the Li₂O component, and the Na₂O component can be 80.0% or more, 85.0% or more, 90.0% or more, 92.0% or more, or 95.0% or more.

In one aspect, the total content of the SiO₂ component, the Al₂O₃ component, the MgO component, the TiO₂ component, the Li₂O component, the Na₂O component, the P₂O₅ component, the CaO component, the SrO component, and the Sb₂O₃ component can be 90.0% or more, 92.0% or more, 95.0% or more, 97.0% or more, 98.0% or more, or 99.0% or more.

### (Crystallization Method)

A heat treatment for crystal precipitation may be performed at a one-stage temperature or a two-stage temperature.

In a two-stage heat treatment, first, a nucleation step is performed by performing a heat treatment at a first temperature, and after the nucleation step, a crystal growth step is performed by performing a heat treatment at a second temperature higher than that of the nucleation step.

The first temperature of the two-stage heat treatment can be set to preferably 400° C. to 750° C., and more preferably 450° C. to 720° C. The retention time at the first temperature is preferably 30 minutes to 2000 minutes, and more preferably 60 minutes to 1440 minutes.

The second temperature of the two-stage heat treatment can be set to preferably 550° C. to 850° C., and more preferably 600° C. to 800° C. or 600° C. to 780° C. The retention time at the second temperature is preferably 30 minutes to 600 minutes, and more preferably 60 minutes to 400 minutes.

### [Inorganic Composition Article]

The inorganic composition article according to one aspect of the present invention has a compressive stress layer on a surface thereof, and can be produced by performing a strengthening treatment using the crystallized glass as a base material. The inorganic composition article is, for example, a strengthened crystallized glass.

The inorganic composition article has a compressive stress layer on a surface, and therefore crack extension can be prevented and the mechanical strength can be enhanced.

When the outermost surface of the inorganic composition article is defined as zero depth, the compressive stress on the outermost surface (surface compressive stress) is CS. The depth (thickness) of the compressive stress layer when the compressive stress is 0 MPa is denoted by DOLzero.

In one aspect, the surface compressive stress value (CS) of the compressive stress layer is 200 MPa or more, 350 MPa or more, or 450 MPa or more. The upper limit of the CS can be, for example, 1100 MPa or less, 1000 MPa or less, or 900 MPa or less.

The CS is measured by the method described in examples.

In one aspect, the central tensile stress (CT) of the compressive stress layer is 3 MPa or more, 4 MPa or more, or 10 MPa or more. The upper limit of the CT can be, for example, 100 MPa or less, 90 MPa or less, or 80 MPa or less.

The CT is measured by the method described in examples.

In one aspect, the depth of the compressive stress layer (DOLzero) is 80 μm or more, 90 μm or more, 100 μm or more, 110 μm or more, 120 μm or more, 130 μm or more, or 140 μm or more. The upper limit can be, for example, 300 μm or less, or 200 μm or less.

When the compressive stress layer is deep, even if a deep crack occurs on the surface, it is possible to prevent crack extension or breakage of the substrate.

In one aspect, the ratio of the depth (thickness) DOLzero of the compressive stress layer on the surface to the thickness t of the inorganic composition article (DOLzero/t) is 7% or more and 25% or less. The DOLzero depends on the thickness of the inorganic composition article (the thickness of the crystallized glass as a raw material), and the fact that the ratio (DOLzero/t) is 7% or more indicates that a compressive stress layer having a sufficient thickness is formed and the impact resistance is high.

In one aspect, the DOLzero/t is 8% or more, 10% or more, or 12% or more. The upper limit may be, for example, 23% or less or 20% or less.

The lower limit of the thickness of the crystallized glass (glass substrate) as the base material may be, for example, 0.10 mm or more, 0.20 mm or more, or 0.40 mm or more. The upper limit of the thickness of the glass substrate may be, for example, 10.00 mm or less, 5.00 mm or less, 1.00 mm or less, 0.90 mm or less, or 0.80 mm or less.

In one aspect, the inorganic composition article has a Vickers hardness (Hv) of 700 or more, 730 or more, 750 or more, or 770 or more. The upper limit may be, for example, 900 or less or 870 or less.

The Vickers hardness (Hv) is measured by a method described in examples.

In one aspect, the inorganic composition article has the same light transmittance as the above-described crystallized glass. That is, as the light transmittance (spectral transmittance at 400 nm, 550 nm, or 700 nm measured for a 1 mm thick sample) of the inorganic composition article, the same contents as those of the above-described crystallized glass can be referred to.

### (Method for Forming Compressive Stress Layer)

Examples of a method for forming a compressive stress layer in the inorganic composition article (for example, strengthened crystallized glass) include a chemical strengthening method in which an alkali component present in a surface layer of crystallized glass is subjected to an exchange reaction with an alkali component having an ionic radius larger than that of the alkali component of the surface layer to form a compressive stress layer on the surface layer. There are a thermal strengthening method in which a crystallized glass is heated and then rapidly cooled, and an ion implantation method in which ions are implanted into a surface layer of a crystallized glass.

The chemical strengthening method can be performed, for example, in the following steps. A crystallized glass is brought into contact with or immersed in a molten salt of a salt containing potassium or sodium, for example, potassium nitrate (KNO₃), sodium nitrate (NaNO₃), or a mixed salt or a composite salt thereof. The treatment (chemical strengthening treatment) of contacting with or immersing in the molten salt may be performed in one stage or in two stages.

For example, in the case of a two-stage chemical strengthening treatment, firstly, contacting with or immersing in a sodium salt or a mixed salt of potassium and sodium heated at 350° C. to 550° C. is performed for 1 to 1440 minutes, preferably 30 to 500 minutes. Subsequently, secondly, contacting with or immersing in a potassium salt or a mixed salt of potassium and sodium heated at 350° C. to 550° C. is performed for 1 to 1440 minutes, preferably 60 to 600 minutes.

In the case of a one-stage chemical strengthening treatment, contacting with or immersing in a salt containing potassium or sodium or a mixed salt thereof heated at 350° C. to 550° C. is performed for 1 to 1440 minutes.

The thermal strengthening method is not particularly limited, but for example, by heating a crystallized glass to 300° C. to 600° C. and then performing rapid cooling such as water cooling and/or air cooling, a compressive stress layer can be formed by a temperature difference between the surface and the inside of the glass. The compressive stress layer can be more effectively formed by combining with the chemical treatment method.

The ion implantation method is not particularly limited, but for example, ions are implanted into the surface by causing arbitrary ions to collide with the surface of a crystallized glass at an acceleration energy and an acceleration voltage to such an extent that the surface is not broken. Thereafter, a heat treatment is performed as necessary, whereby a compressive stress layer can be formed on the surface in the same manner as in the other methods.

### EXAMPLES

### 1. Production and Evaluation of Crystallized Glass

### Examples 1 to 23 and Comparative Examples 1 to 3

### (1) Preparation of Raw Materials

As raw materials of respective components of a crystallized glass, raw materials of oxides corresponding thereto were selected, and these raw materials were weighed so as to have the composition (mass %) shown in Tables 1 and 2, and uniformly mixed.

### (2) Production of Crystallized Glass

Next, the mixed raw materials were put into a platinum crucible and melted at 1300° C. to 1540° C. in an electric furnace according to the ease of melting of the glass composition. Thereafter, the molten glass was stirred to be homogenized, and the glass was then cast into a mold and slowly cooled to produce a raw glass.

The obtained raw glass was heated under nucleation conditions and crystallization (crystal growth) conditions shown in Tables 1 and 2 to produce a crystallized glass. In Tables 1 and 2, “-” indicates that the corresponding step was not performed.

### (3) X-Ray Diffraction (XRD) Measurement

The crystalline phase contained in the crystallized glass obtained in (2) was measured using an automatic X-ray diffractometer (“D8 DISCOVER” manufactured by Bruker) in accordance with JIS K 0131 (1996). In the crystallized glass obtained in (2), since an X-ray diffraction peak was observed, it was verified that a crystalline phase was generated.

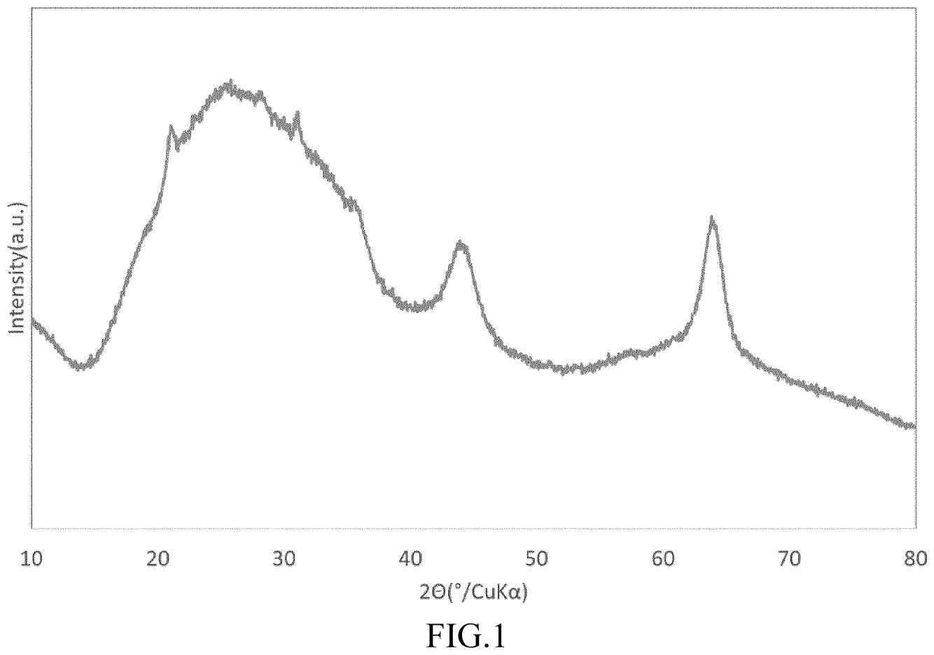

The X-ray diffraction spectrum obtained in Example 2 is shown in FIG. 1. It was verified that the glass was crystallized. In the X-ray diffraction spectrum, the vertical axis represents the intensity (counts, no units), and the horizontal axis represents 2θ.

### (4) Measurement of Light Transmittance (Spectral Transmittance)

With reference to the Japan Optical Glass Industry Association standard JOGIS-02 (2019) “Measuring Method for Color-Degree of Optical Glass”, the spectral transmittances at 400 nm, 550 nm, and 700 nm of the crystallized glass (1 mm thick sample with polished opposite parallel faces) obtained in (2) were measured using a spectrophotometer (“U-4100” manufactured by Hitachi, Ltd.). The results are shown in Tables 1 and 2.

### (5) Measurement of Vickers Hardness (Hv0.2)

With respect to the crystallized glass obtained in (2), a Vickers hardness was expressed as a value obtained by dividing the load when a pyramidal indentation was provided on a sample surface using a diamond quadrangular pyramid indenter having a facing angle of 136° by the surface area (mm²) calculated from the length of the indentation. Measurement was performed with a test load of 200 gf and a retention time of 15 seconds using Micro Vickers hardness tester HMV-G21D manufactured by Shimadzu Corporation. The results are shown in Tables 1 and 2.

### 2. Production and Evaluation of Strengthened Crystallized Glass (Inorganic Composition Article)

### Examples 2-1 to 2-3, 4-1, 5-1, 5-2, 6-1,10-1, 12-1, 13-1, 15-1, 16-1, 17-1, 18-1, 19-1, 20-1, 22-1, 23-1 to 23-10, Comparative Example 1-1, Comparative Example 2-1, and Comparative Example 3-1

### (1) Production of Strengthened Crystallized Glass

The crystallized glass obtained in 1. (2) was cut and ground, and opposite parallel faces were polished so as to have a thickness shown in Tables 3 to 8 to obtain a crystallized glass substrate.

The obtained crystallized glass substrate was chemically strengthened under conditions shown in Tables 3 to 8 to obtain a strengthened crystallized glass. For example, in Example 2-1, it is shown that the crystallized glass obtained in Example 2 was used as a crystallized glass substrate, and immersed in a NaNO₃ salt bath at 500° C. for 6 hours (360 minutes) (first stage), and then immersed in a KNO₃ salt bath at 500° C. for 3 hours (180 minutes) (second stage) to produce a strengthened crystallized glass. In addition, for example, the description of “KNO₃ 1:NaNO₃ 2” in Example 2-3 indicates that the crystallized glass substrate was immersed in a mixed bath containing KNO₃ and NaNO₃ at 1:2 (mass ratio).

### (2) Measurement of Surface Compressive Stress Value (CS)

The surface compressive stress value of the strengthened crystallized glass obtained in (1) was measured. The surface compressive stress value (CS) was measured using a glass surface stress meter FSM-6000LE series manufactured by Orihara Industrial Co., Ltd. As a light source of the measuring instrument used in the CS measurement, a light source having a wavelength of 596 nm was selected. As the refractive index used in the CS measurement, a refractive index value at 596 nm was used. A refractive index value at a wavelength of 596 nm was calculated using a quadratic approximation expression from the measured values of the refractive index at wavelengths of C-line, d-line, F-line, and g-line according to the V-block method specified in JIS B 7071-2:2018. The value of the photoelastic constant at 596 nm used in the CS measurement was calculated using a quadratic approximation expression from the measured values of the photoelastic constants at a wavelength of 435.8 nm, a wavelength of 546.1 nm, and a wavelength of 643.9 nm. The results are shown in Tables 3 to 8.

### (3) Measurement of Depth of Compressive Stress Layer DOLzero (μm) and Central Tensile Stress (CT)

The depth DOLzero (μm) and the central tensile stress (CT) of the compressive stress layer in the strengthened crystallized glass obtained in (1) were measured using a scattered light photoelastic stress meter SLP-1000. A light source having a wavelength of 520 nm was selected as a measurement light source used for these measurements. As the refractive index used for these measurements, a refractive index value at 520 nm was used. A refractive index value at a wavelength of 520 nm was calculated by using a quadratic approximation expression from the measured values of the refractive index at wavelengths of C-line, d-line, F-line, and g-line according to the V-block method specified in JIS B 7071-2:2018. The value of the photoelastic constant at 640 nm used for these measurements was calculated using a quadratic approximation expression from the measured values of the photoelastic constants at a wavelength of 435.8 nm, a wavelength of 546.1 nm, and a wavelength of 643.9 nm. The results are shown in Tables 3 to 8.

### (4) Ratio of DOLzero to Thickness of Crystallized Glass Substrate

The ratio of DOLzero to the thickness of the crystallized glass substrate (DOLzero/t) [%] was determined by dividing DOLzero determined in (3) by the thickness t of the crystallized glass substrate. The results are shown in Tables 3 to 8.

### (5) Measurement of Vickers Hardness (Hv0.2)

The Vickers hardness of the strengthened crystallized glass obtained in (1) was measured. The measurement method is the same as in 1. (5). The results are shown in Tables 3 to 8.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Raw glass | SiO₂ | | 45.69 | 45.69 | 45.69 | 45.69 | 45.69 | 45.69 | 45.69 | 45.69 | 44.79 |
| composition | Al₂O₃ | | 18.27 | 18.27 | 18.27 | 15.27 | 18.27 | 18.27 | 18.27 | 18.27 | 17.91 |
| [mass. %] | P₂O₅ | | | | | | | | | | 1.96 |
| | B₂O₃ | | | | | | | | | | |
| | Li₂O | | 0.61 | 0.61 | 0.61 | 0.61 | 1.63 | 0.61 | 1.61 | 0.61 | 0.60 |
| | Na₂O | | 4.06 | 4.06 | 4.06 | 4.06 | 4.06 | 4.06 | 3.06 | 3.06 | 3.98 |
| | K₂O | | | | | | | | | 1.00 | |
| | MgO | | 19.49 | 19.49 | 19.49 | 22.49 | 19.49 | 19.49 | 19.49 | 19.49 | 19.11 |
| | CaO | | 1.02 | 1.02 | 1.02 | 1.02 | 1.02 | 2.04 | 1.02 | 1.02 | 1.00 |
| | SrO | | 1.02 | 1.02 | 1.02 | 1.02 | | | 1.02 | 1.02 | 1.00 |
| | BaO | | | | | | | | | | |
| | ZnO | | | | | | | | | | |
| | TiO₂ | | 9.75 | 9.75 | 9.75 | 9.75 | 9.75 | 9.75 | 9.75 | 9.75 | 9.56 |
| | ZrO₂ | | | | | | | | | | |
| | Sb₂O₃ | | 0.10 | 0.10 | 0.10 | 0.10 | 0.10 | 0.10 | 0.10 | 0.10 | 0.10 |
| | Total | | 100.00 | 100.00 | 100.00 | 100.00 | 100.00 | 100.00 | 100.00 | 100.00 | 100.00 |
| | Li₂O + Na₂O + K₂O | | 4.67 | 4.67 | 4.67 | 4.67 | 5.69 | 4.67 | 4.67 | 4.67 | 4.58 |
| | MgO/(MgO + CaO + SrO + BaO + ZnO) | | 0.91 | 0.91 | 0.91 | 0.92 | 0.95 | 0.91 | 0.91 | 0.91 | 0.91 |
| Crystallization | Nucleation | Temperature [° C.] | — | 700 | 700 | 700 | 700 | 700 | 700 | 700 | 700 |
| condition | | Retention time [min] | — | 180 | 180 | 180 | 180 | 180 | 180 | 180 | 180 |
| | Crystal growth | Temperature [° C.] | 750 | 750 | 740 | 740 | 720 | 750 | 720 | 750 | 760 |
| | | Retention time [min] | 360 | 360 | 360 | 360 | 360 | 360 | 360 | 360 | 360 |
| Crystallized | Spectral | 400 nm transmittance | 78.6 | 77.3 | 80.4 | 69.8 | 70.9 | 75.6 | 79.9 | 80.1 | 76.3 |
| glass | transmittance | 550 nm transmittance | 84.9 | 83.2 | 83.8 | 82.4 | 83.3 | 83.5 | 84.0 | 83.7 | 83.6 |
| | [%] | 700 nm transmittance | 88.4 | 88.0 | 88.2 | 87.6 | 88.0 | 88.0 | 88.3 | 88.2 | 88.1 |
| | (thickness: 1 mm) | | | | | | | | | | |

| | | | | | | | | | |
|---|---|---|---|---|---|---|---|---|---|
| Hv0.2 | 802 | 772 | 754 | 777 | 793 | 793 | 777 | 763 | 759 |

| | | | Example | | | | | | | | |
|---|---|---|---|---|---|---|---|---|---|---|---|
| | | | 10 | 11 | 12 | 13 | 14 | 15 | 16 | 17 | 18 |
| Raw glass | SiO₂ | | 45.69 | 45.69 | 46.69 | 45.69 | 45.69 | 46.19 | 47.44 | 46.69 | 46.69 |
| composition | Al₂O₃ | | 18.27 | 18.27 | 18.27 | 18.27 | 18.27 | 18.27 | 18.27 | 18.27 | 18.27 |
| [mass. %] | P₂O₅ | | | | | | | | | | |
| | B₂O₃ | | | | | | | | | | |
| | Li₂O | | 0.61 | 2.13 | 2.13 | 2.13 | 1.63 | 2.13 | 2.13 | 1.63 | 1.63 |
| | Na₂O | | 6.10 | 4.06 | 4.06 | 3.56 | 3.56 | 4.06 | 4.06 | 4.06 | 5.06 |
| | K₂O | | | | | | 0.50 | 0.25 | 0.25 | 0.50 | |
| | MgO | | 19.49 | 19.49 | 18.49 | 19.49 | 19.49 | 18.99 | 17.49 | 17.99 | 17.49 |
| | CaO | | | 1.02 | 0.52 | 1.02 | 1.02 | 1.02 | 0.52 | 1.02 | 1.02 |
| | SrO | | | | | | | | | | |
| | BaO | | | | | | | | | | |
| | ZnO | | | | | | | | | | |
| | TiO₂ | | 9.75 | 9.25 | 9.75 | 9.75 | 9.75 | 9.00 | 9.75 | 9.75 | 9.75 |
| | ZrO₂ | | | | | | | | | | |
| | Sb₂O₃ | | 0.10 | 0.10 | 0.10 | 0.10 | 0.10 | 0.10 | 0.10 | 0.10 | 0.10 |
| | Total | | 100.00 | 100.00 | 100.00 | 100.00 | 100.00 | 100.00 | 100.00 | 100.00 | 100.00 |
| | Li₂O + Na₂O + K₂O | | 6.71 | 6.19 | 6.19 | 5.69 | 5.69 | 6.44 | 6.44 | 6.19 | 6.69 |
| | MgO/(MgO + CaO + SrO + BaO + ZnO) | | 1.00 | 0.95 | 0.97 | 0.95 | 0.95 | 0.95 | 0.97 | 0.95 | 0.94 |
| Crystallization | Nucleation | Temperature [° C.] | 700 | 600 | 600 | 600 | 600 | 600 | 600 | 600 | 600 |
| condition | | Retention time [min] | 180 | 180 | 180 | 180 | 180 | 180 | 180 | 180 | 180 |
| | Crystal growth | Temperature [° C.] | 720 | 680 | 700 | 710 | 710 | 700 | 680 | 700 | 700 |
| | | Retention time [min] | 360 | 360 | 360 | 360 | 360 | 360 | 360 | 360 | 360 |
| Crystallized | Spectral | 400 nm transmittance | 80.3 | 81.9 | 81.2 | 79.5 | 81.1 | 79.4 | 81.3 | 81.8 | 81.8 |
| glass | transmittance | 550 nm transmittance | 83.9 | 85.1 | 84.6 | 84.7 | 84.4 | 85.8 | 84.9 | 85.0 | 84.9 |
| | [%] | 700 nm transmittance | 88.5 | 88.7 | 88.6 | 88.4 | 88.4 | 88.8 | 88.7 | 88.7 | 88.8 |
| | (thickness: 1 mm) | | | | | | | | | | |

| | | | | | | | | | |
|---|---|---|---|---|---|---|---|---|---|
| Hv0.2 | 733 | 770 | 761 | 781 | 768 | 781 | 757 | 761 | 748 |

TABLE 2

| | | | Example | | | | | Comparative Example | | |
|---|---|---|---|---|---|---|---|---|---|---|
| | | | 19 | 20 | 21 | 22 | 23 | 1 | 2 | 3 |
| Raw glass | SiO₂ | | 46.69 | 47.19 | 45.69 | 46.69 | 47.45 | 52.70 | 48.00 | 48.57 |
| composition | Al₂O₃ | | 18.27 | 18.27 | 18.27 | 18.27 | 18.30 | 16.00 | 19.00 | 14.04 |
| [mass. %] | P₂O₅ | | | | | | | | | |
| | B₂O₃ | | | | | | | | | |
| | Li₂O | | 1.63 | 2.13 | 1.63 | 2.13 | 2.13 | | | |
| | Na₂O | | 5.56 | 5.06 | 4.06 | 4.06 | 4.05 | | | 4.22 |
| | K₂O | | | | | | 0.25 | | | |
| | MgO | | 17.49 | 16.99 | 19.49 | 18.49 | 17.50 | 15.00 | 18.00 | 18.27 |
| | CaO | | 1.02 | 0.52 | 1.02 | 0.52 | 0.50 | 1.40 | 1.00 | 1.06 |
| | SrO | | | | | | | 1.40 | 1.00 | 1.06 |
| | BaO | | | | | | | 3.50 | 2.50 | 2.53 |
| | ZnO | | | | | | | | | |
| | TiO₂ | | 9.25 | 9.75 | 8.00 | 8.00 | 9.75 | 9.00 | 10.00 | 10.14 |
| | ZrO₂ | | | | 1.75 | 1.75 | | 0.80 | | |
| | Sb₂O₃ | | 0.10 | 0.10 | 0.10 | 0.10 | 0.07 | 0.20 | 0.50 | 0.11 |
| | Total | | 100.00 | 100.00 | 100.00 | 100.00 | 100.00 | 100.00 | 100.00 | 100.00 |
| | Li₂O + Na₂O + K₂O | | 7.19 | 7.19 | 5.69 | 6.19 | 6.43 | 0.00 | 0.00 | 4.22 |
| | MgO/(MgO + CaO + SrO + BaO + ZnO) | | 0.94 | 0.97 | 0.95 | 0.97 | 0.97 | 0.70 | 0.80 | 0.80 |
| Crystallization | Nucleation | Temperature [° C.] | 600 | 600 | 600 | 600 | 600 | — | — | — |
| condition | | Retention time [min] | 180 | 180 | 180 | 180 | 180 | — | — | — |
| | Crystal growth | Temperature [° C.] | 700 | 680 | 700 | 700 | 690 | 950 | 850 | 800 |
| | | Retention time [min] | 360 | 360 | 360 | 360 | 360 | 120 | 360 | 360 |
| Crystallized glass | Spectral | 400 nm transmittance | 82.0 | 80.2 | 82.0 | 82.8 | 79.2 | 0.04 | 0.02 | 52.8 |
| | transmittance[%] | 550 nm transmittance | 85.5 | 84.3 | 85.4 | 85.7 | 83.4 | 2.5 | 0.3 | — |
| | (thickness: 1 mm) | 700 nm transmittance | 89.0 | 88.7 | 88.8 | 89.0 | 88.4 | 25.8 | 0.7 | — |

| | | | | | | | | |
|---|---|---|---|---|---|---|---|---|
| Hv0.2 | 754 | 752 | 761 | 759 | 729 | 834 | 863 | 802 |

TABLE 3

| | | Example 2-1 | Example 2-2 | Example 2-3 | Example 4-1 | Example 5-1 |
|---|---|---|---|---|---|---|
| Crystallized glass substrate | | Example 2 | Example 2 | Example 2 | Example 4 | Example 5 |
| Substrate thickness t (mm) | | 1.0 | 1.0 | 1.0 | 1.0 | 1.0 |
| Strengthening | First stage | NaNO₃ | NaNO₃ | KNO₃ 1: | NaNO₃ | NaNO₃ |
| Condition | | | | NaNO₃ 2 | | |
| | | 500° C. × | 470° C. × | 500° C. × | 500° C. × | 500° C. × |
| | | 360 min | 480 min | 360 min | 360 min | 360 min |
| | Second stage | KNO₃ | KNO₃ 50: | KNO₃ 50: | KNO₃ | KNO₃ |
| | | | NaNO₃ 1 | NaNO₃ 1 | | |
| | | 500° C. × | 500° C. × | 470° C. × | 500° C. × | 500° C. × |
| | | 180 min | 180 min | 120 min | 180 min | 180 min |
| Strengthened | CS [Mpa] | 715 | 690 | 663 | 773 | 860 |
| crystallized | DOLzero [μm] | 144 | 136 | 129 | 132 | 161 |
| glass | DOLzero/t [%] | 14.4 | 13.6 | 12.9 | 13.2 | 16.1 |
| | CT [MPa] | 31 | 27 | 30 | 27 | 68 |
| | Hv0.2 | 805 | 777 | 783 | 797 | 852 |

TABLE 4

| | | Example 5-2 | Example 6-1 | Example 10-1 | Example 12-1 | Example 13-1 |
|---|---|---|---|---|---|---|
| Crystallized glass substrate | | Example 5 | Example 6 | Example 10 | Example 12 | Example 13 |
| Substrate thickness t (mm) | | 1.0 | 1.0 | 1.0 | 1.0 | 1.0 |
| Strengthening | First stage | KNO₃ 1: | NaNO₃ | KNO₃ 1: | NaNO₃ | NaNO₃ |
| Condition | | NaNO₃ 2 | | NaNO₃ 2 | | |
| | | 500° C. × | 500° C. × | 500° C. × | 500° C. × | 500° C. × |
| | | 360 min | 360 min | 360 min | 360 min | 360 min |
| | Second stage | KNO₃ 50: | KNO₃ | KNO₃ 50: | KNO₃ | KNO₃ |
| | | NaNO₃ 1 | | NaNO₃ 1 | | |
| | | 470° C. × | 500° C. × | 470° C. × | 500° C. × | 500° C. × |
| | | 120 min | 180 min | 120 min | 180 min | 180 min |
| Strengthened | CS [Mpa] | 595 | 677 | 653 | 818 | 792 |
| crystallized | DOLzero [μm] | 148 | 137 | 177 | 178 | 163 |
| glass | DOLzero/t [%] | 14.8 | 13.7 | 17.7 | 17.8 | 16.3 |
| | CT [MPa] | 75 | 34 | 36 | 83 | 83 |
| | Hv0.2 | 819 | 809 | 774 | 819 | 844 |

TABLE 5

| | | Example 15-1 | Example 16-1 | Example 17-1 | Example 18-1 | Example 19-1 |
|---|---|---|---|---|---|---|
| Crystallized glass substrate | | Example 15 | Example 16 | Example 17 | Example 18 | Example 19 |
| Substrate thickness t (mm) | | 1.0 | 1.0 | 1.0 | 1.0 | 1.0 |
| Strengthening | First stage | NaNO₃ | NaNO₃ | NaNO₃ | NaNO₃ | NaNO₃ |
| Condition | | 500° C. × | 500° C. × | 500° C. × | 500° C. × | 500° C. × |
| | | 360 min | 360 min | 360 min | 360 min | 360 min |
| | Second stage | KNO₃ | KNO₃ | KNO₃ | KNO₃ | KNO₃ |
| | | 500° C. × | 500° C. × | 500° C. × | 500° C. × | 500° C. × |
| | | 180 min | 180 min | 180 min | 180 min | 180 min |
| Strengthened | CS [Mpa] | 847 | 867 | 837 | 880 | 895 |
| crystallized | DOLzero [μm] | 171 | 168 | 158 | 160 | 160 |
| glass | DOLzero/t [%] | 17.1 | 16.8 | 15.8 | 16.0 | 16.0 |
| | CT [MPa] | 86 | 91 | 72 | 73 | 72 |
| | Hv0.2 | 832 | 805 | 814 | 817 | 817 |

TABLE 6

| | | Example 20-1 | Example 22-1 | Example 23-1 | Example 23-2 | Example 23-3 |
|---|---|---|---|---|---|---|
| Crystallized glass substrate | | Example 20 | Example 22 | Example 23 | Example 23 | Example 23 |
| Substrate thickness t (mm) | | 1.0 | 1.0 | 1.0 | 0.6 | 0.6 |
| Strengthening | First stage | NaNO₃ | NaNO₃ | NaNO₃ | NaNO₃ | NaNO₃ |
| Condition | | 500° C. × | 500° C. × | 490° C. × | 490° C. × | 490° C. × |
| | | 360 min | 360 min | 360 min | 360 min | 60 min |
| | Second stage | KNO₃ | KNO₃ | KNO₃ | KNO₃ | KNO₃ |
| | | 500° C. × | 500° C. × | 490° C. × | 490° C. × | 490° C. × |
| | | 180 min | 180 min | 180 min | 180 min | 300 min |
| Strengthened | CS [Mpa] | 859 | 881 | 769 | 807 | 1045 |
| crystallized | DOLzero [μm] | 177 | 161 | 176 | 76 | 94 |
| glass | DOLzero/t [%] | 17.7 | 16.1 | 17.6 | 12.7 | 15.7 |
| | CT [MPa] | 87 | 84 | 74 | 56 | 58 |
| | Hv0.2 | 814 | 800 | 795 | 795 | 786 |

TABLE 7

| | | Example 23-4 | Example 23-5 | Example 23-6 | Example 23-7 | Example 23-8 |
|---|---|---|---|---|---|---|
| Crystallized glass substrate | | Example 23 | Example 23 | Example 23 | Example 23 | Example 23 |
| Substrate thickness t (mm) | | 0.6 | 0.6 | 0.6 | 0.6 | 0.6 |
| Strengthening | First stage | NaNO₃ | NaNO₃ | NaNO₃ | NaNO₃ | NaNO₃ |
| Condition | | 490° C. × | 490° C. × | 490° C. × | 490° C. × | 490° C. × |
| | | 360 min | 360 min | 120 min | 420 min | 120 min |
| | Second stage | KNO₃ | KNO₃ | KNO₃ | KNO₃ | KNO₃ |
| | | 490° C. × | 420° C. × | 420° C. × | 420° C. × | 430° C. × |
| | | 60 min | 390 min | 300 min | 120 min | 240 min |
| Strengthened | CS [Mpa] | 915 | 952 | 1088 | 717 | 1056 |
| crystallized | DOLzero [μm] | 90 | 93 | 95 | 89 | 82 |
| glass | DOLzero/t [%] | 15.0 | 15.5 | 15.8 | 14.8 | 13.7 |
| | CT [MPa] | 79 | 69 | 69 | 77 | 69 |
| | Hv0.2 | 772 | 768 | 786 | 778 | 785 |

TABLE 8

| | | Example 23-9 | Example 23-10 | Com. Ex. 1-1 | Com. Ex. 2-1 | Com. Ex. 3-1 |
|---|---|---|---|---|---|---|
| Crystallized glass substrate | | Example 23 | Example 23 | Com. Ex. 1 | Com. Ex. 2 | Com. Ex. 3 |
| Substrate thickness t (mm) | | 0.6 | 0.6 | 10 | 10 | 10 |
| Strengthening | First stage | NaNO₃ | NaNO₃ | KNO₃ | KNO₃ | KNO₃ |
| Condition | | 490° C. × | 490° C. × | 500° C. × | 450° C. × | 500° C. × |
| | | 240 min | 360 min | 480 min | 480 min | 480 min |
| | Second stage | KNO₃ | KNO₃ | — | — | — |
| | | 450° C. × | 430° C. × | — | — | — |
| | | 240 min | 240 min | | | |
| Strengthened | CS [Mpa] | 899 | 1064 | Not measurable | Not measurable | 707 |
| crystallized | DOLzero [μm] | 97 | 96 | Not measurable | Not measurable | 38 |
| glass | DOLzero/t [%] | 16.2 | 16.0 | Not measurable | Not measurable | 0.38 |
| | CT [MPa] | 65 | 65 | Not measurable | Not measurable | 3 |
| | Hv0.2 | 805 | 786 | 799 | 836 | 915 |

From Tables 1 to 8, it can be seen that the crystallized glasses of examples had a high strength, and exhibited excellent numerical values of light transmittance at any of 400 nm, 550 nm, and 700 nm, and could achieve both strength and transparency at a high level. In addition, it can be seen that a thick compressive stress layer could be formed by a two-stage chemical strengthening treatment, and a strengthened crystallized glass having excellent impact resistance was obtained.

On the other hand, it can be seen that the crystallized glasses of Comparative Examples 1 and 2 have a high strength (hardness), but have an extremely low light transmittance at any wavelength, and are poor in transparency. In addition, since the strength was not improved even when these crystallized glasses were subjected to a chemical strengthening treatment, it is considered that these crystallized glasses were not chemically strengthened and a compressive stress layer was not formed (Comparative Examples 1-1 and 2-1). In these examples, rather, the surface was roughened and the strength was reduced by immersion in a salt bath. That is, a strengthened crystallized glass having high impact resistance was not obtained. It can be seen that the crystallized glass of Comparative Example 3 has a high strength (hardness), but has a low light transmittance and insufficient transparency. Although this crystallized glass could be chemically strengthened, the thickness of the obtained compressive stress layer (DOLzero/t) was smaller than that in examples (Comparative Example 3-1).

Although several embodiments and/or examples of the present invention have been described in detail above, those skilled in the art will readily be able to make many modifications to these illustrative embodiments and/or examples without substantially departing from the novel teachings and advantageous effects of the present invention. Therefore, many of these modifications fall within the scope of the present invention.

The entirety of contents of all documents cited in this description and of the application on which priority under the Paris Convention of the present application is based are incorporated herein.

1. A crystallized glass comprising, in mass % on an oxide basis:
a SiO₂ component: 40.0 to 55.0%,
an Al₂O₃ component: 10.0 to 30.0%,
a MgO component: 10.0 to 30.0%,
a TiO₂ component: 5.0 to 15.0%,
a Li₂O component: more than 0 to 5.0%, and
a Na₂O component: more than 0 to 8.0%, wherein
a total content of the Li₂O component, the Na₂O component, and the K₂O component [content of Li₂O component+content of Na₂O component+content of K₂O component] is more than 0 to 12.0%,
a Vickers hardness (Hv) is 700 or more, and
a spectral transmittance at 400 nm measured for a 1 mm thick sample is 60% or more.

2. The crystallized glass according to claim 1, wherein the content of the MgO component with respect to a total content of the MgO component, a CaO component, a SrO component, a BaO component, and a ZnO component [content of MgO component/(content of MgO component+content of CaO component+content of SrO component+content of BaO component+content of ZnO component)] is 0.45 or more.

3. The crystallized glass according to claim 1, comprising,
in mass % on an oxide basis:
a B₂O₃ component: 0 to 5.0%,
a P₂O₅ component: 0 to 5.0%,
a K₂O component: 0 to 5.0%,
a CaO component: 0 to 5.0%,
a SrO component: 0 to 5.0%,
a BaO component: 0 to 5.0%,
a ZnO component: 0 to 5.0%,
a ZrO₂ component: 0 to 8.0%, and
a Sb₂O₃ component: 0 to 2.0%.

4. An inorganic composition article having a compressive stress layer on a surface thereof, obtained by chemically strengthening the crystallized glass according to claim 1.

5. The inorganic composition article according to claim 4, wherein the ratio of the thickness DOLzero of the compressive stress layer on the surface to the thickness t of the substrate of the inorganic composition article (DOLzero/t) is 7% or more and 25% or less.
